(19) United States
(12) Patent Application Publication
(10) Pub. No.: US 2010/0179701 A1
(43) Pub. Date: Jul. 15, 2010

(54) IRRIGATION SYSTEM WITH WIRELESS CONTROL

(75) Inventors: Quenton Lanier Gilbert, Sandy Springs, GA (US); James Carlton Bedingfield, SR., Lilburn, GA (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/353,146

(22) Filed: Jan. 13, 2009

(51) Int. Cl. G05D 7/06

(52) U.S. Cl. 700/284

(57) ABSTRACT

A disclosed method of weather forecasting with respect to a set of irrigation criteria includes enabling an irrigation system controller operating on a user defined schedule to wirelessly receive soil condition information from an environmental sensor, evaluate the soil condition information for satisfaction of an irrigation criterion, and activate an irrigation valve associated with the environmental sensor when the irrigation criterion is satisfied. The soil condition information may indicate a chemical composition or moisture content of the soil. The irrigation system controller is further enabled to generate a warning message based on the soil condition. The irrigation system controller is further enabled to send the warning message to a lawn care service. The irrigation system controller is further enabled to generate a report of the soil condition. The irrigation system controller is further enabled to generate a report indicative of water consumption per irrigation valve.

### BACKGROUND

1. Field of the Disclosure

The present disclosure relates to irrigation systems and, more particularly, irrigation systems with automated controllers.

2. Description of the Related Art

Automated irrigation systems enable home owners, business owners, property managers, and others to water grass and other landscaping features according to a user-defined schedule. A programmable controller operates a set of one or more electrically controllable valves and corresponding sprinkler heads according to the defined schedule. Some automated irrigation systems may also have limited ability to defer or suspend watering during a rain storm or shortly thereafter.

### BRIEF DESCRIPTION OF THE DRAWINGS

FIG. 1 depicts selected aspects of an embodiment of an irrigation system;

FIG. 2 depicts selected aspects of an embodiment of an environmental sensor suitable for use in an irrigation system such as the irrigation system of FIG. 1;

FIG. 3 depicts selected aspects of an embodiment of a controller suitable for use in an automated irrigation system such as the irrigation system of FIG. 1;

FIG. 4 depicts an embodiment of a sensor/actuator table suitable for use in an automated irrigation system such as the system of FIG. 1; and

FIG. 5 is a flow diagram of selected aspects of an embodiment of an automated irrigation method.

### DESCRIPTION OF THE EMBODIMENTS

A disclosed irrigation system employs environmental sensors located in or in proximity to irrigation elements such as valves and sprinklers to monitor environmental characteristics of the soil including moisture and chemical content and characteristics of the irrigation system including amount of water, low battery condition, etc. Environmental data is conveyed from the environmental sensors to a central controller by wireless transmission. The central controller can maintain a conventional, calendar based irrigation schedule as a default. The controller may also, however, evaluate the environmental data and, in some cases, externally supplied information including weather forecast information, to override the default irrigation schedule when a specified irrigation criteria is met. Various aspects of the irrigation system are included.

In one aspect, a disclosed irrigation system controller includes a processor, a computer readable storage medium accessible to the processor, a wireless receiver operable for receiving a wireless signal from an environmental sensor, and a set of line outputs suitable for providing operational power to respective valve actuators. A network interface may be configured to connect the controller to an Internet protocol network. In some embodiments, the controller may be configured to communicate with a remote device or service via a cellular network. For example, the controller may be operable to transmit short asynchronous messages leveraging a control channel of a cellular network.

The storage medium may include instructions, executable by the processor, including instructions for interpreting user inputs to define an irrigation schedule and for selectively asserting the set of line outputs based on the irrigation schedule. The executable instructions may further include environmental module instructions for analyzing environmental data encoded in the wireless signal from the environmental sensor to determine whether any irrigation criteria are satisfied and for selectively asserting the set of line outputs based on the analysis.

The environmental data may indicate characteristics of the soil in proximity to the environmental sensor. The environmental data may be indicative, for example, of a moisture content of the soil, a chemical composition of the soil, another characteristic of the soil, or a combination thereof.

The environmental module instructions may further include instructions for receiving weather forecast information from a forecasting source via the network interface and including the weather forecast information with the environmental data during said analyzing. The weather forecast information influences whether the irrigation criteria is satisfied. The processor executable instructions may further include a web server module enabling the controller to receive the user inputs from a web browser.

In another aspect, an irrigation control process as disclosed includes receiving a wireless signal from an environmental sensor and, in response, extracting environmental information from the wireless signal. The environmental information may include soil condition information pertaining to soil in proximity to the environmental sensor. The environmental information may be evaluated with respect to irrigation criteria. When any of the irrigation criteria is satisfied, irrigation is initiated by selectively asserting one or more line outputs to activate corresponding irrigation valves.

In some embodiments, the irrigation control process may further include determining an irrigation schedule based on user input and selectively asserting the set of line outputs based on the irrigation schedule. In this manner, irrigation may occur according to a predetermined or default schedule, but the default schedule may be preempted by current soil conditions, weather forecast information, or a combination thereof.

In some embodiments, local, state, or federal regulations may affect the time and/or duration of watering and, in these embodiments; the regulations may delay or prevent the selective assertion of a line output at a given time. For example, some localities may impose watering restrictions based on the day of the week and/or the time of day. In these locations, the regulations will generally preempt any default water schedule or irrigation criteria that arise.

As already suggested, some embodiments may employ predictive control of the irrigation schedule. For example, some embodiments may include evaluating weather forecast information received from a forecasting source. The weather forecast information may then be considered in conjunction with any environmental data as well as the default irrigation scheduling when evaluating the environmental information with respect to the irrigation criteria.

Some embodiments are implemented as software and/or firmware. These embodiments may include a computer readable storage medium having processor executable instructions for controlling an irrigation system. The instructions may include instructions to interpret environmental information extracted from a wireless signal transmitted from an environmental sensor. The environmental information may be indicative of soil characteristics in proximity to the environmental sensor. The instructions may further include instructions to interpret weather forecast information from a weather forecasting source and evaluate the environmental information and the weather forecast information to determine whether any of a set of irrigation criteria is satisfied. Additional instructions may include instructions to assert a line output associated with the environmental sensor when an irrigation criterion is satisfied.

The method may include determining time of day and/or calendar information from a real time clock and/or determining geographic location from global positioning system data. In these embodiments, the irrigation criteria may be influenced by the time of day, the season, or the geographical location. The computer readable instructions may further include instructions to enable a user to provide the user input via a web browser.

In one aspect, a disclosed method of automating an irrigation system includes enabling an irrigation system controller operating on a user-defined schedule to receive soil condition information wirelessly from an environmental sensor, evaluate the soil condition information for satisfaction of an irrigation criterion, and activate an irrigation valve associated with the environmental sensor when the irrigation criterion is satisfied.

The irrigation system controller may be further enabled to generate a warning message based on the soil condition. The controller may be operable to send the warning message to one or more lawn care services as a request for service or as a request to bid on a service. The irrigation system controller may also be enabled to generate various types of reports including soil condition reports and/or water consumption reports. The water consumption reports may include reports where consumption is tracked as a function of time of day, day of week, month, season, and so forth. Another type of water consumption report may indicate water consumption as a function of the individual irrigation valves or individual sprinklers.

In another aspect, a disclosed sprinkler for use in an irrigation system includes a sprinkler head and an environmental sensor. The sprinkler head is in communication with a fluid conduit. The environmental sensor is positioned on the sprinkler such that the sensor is embedded in the soil when the sprinkler is installed. The sensor is operable to one or more of the following parameters: chemical composition of the soil, moisture content of the soil, precipitation status, volume of water dispensed by the sprinkler, and a low battery condition of the environmental sensor. The sprinkler may be operable to transmit a wireless signal indicative of at least some of the monitored parameters.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

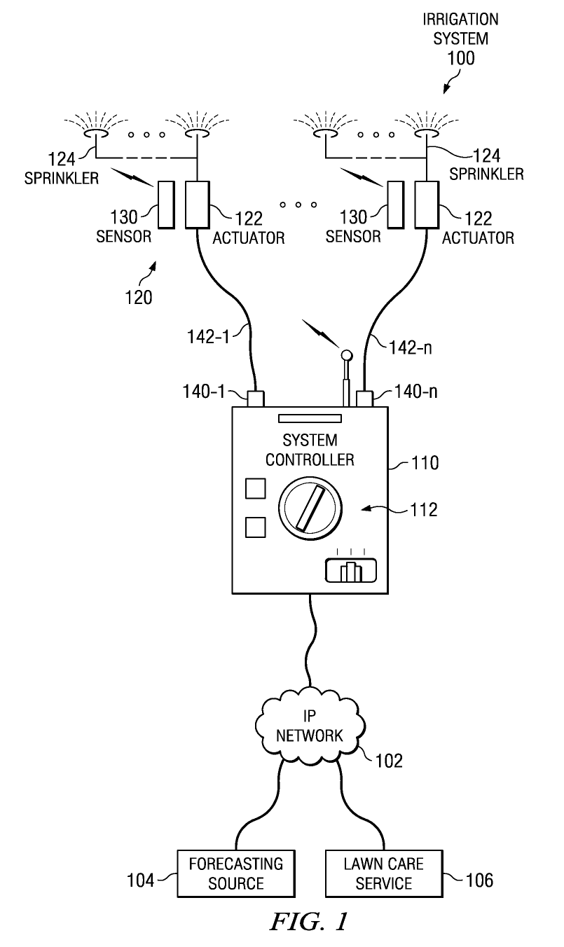

Turning to the drawings, FIG. 1 depicts selected elements of an embodiment of an irrigation system 100 that employs and includes environmental sensors 130 operable to transmit enivornmental data back to the controller. The electronic sensors 130 may be located in proximity to or in close proximity to an actuator 122 for a valve or sprinkler 124. In the depicted embodiment, irrigation system 100 includes an irrigation system controller (ISC) 110 the controls a set of one or more irrigation zones 120. A weather forecasting source 104 and one or more lawn care services 106, only one of which is depicted in FIG. 1, may communicate with ISC 110 via a network such as a public or private Internet protocol network 102.

The irrigation zones 120 depicted in FIG. 1 includes a valve actuator 122 that is connected in parallel or otherwise to a set of a sprlinker heads 124. The actuator 122 includes a valve that may be activated with a solenoid or by another means. An environmental sensor (environmental sensor) 130 is shown in proximity to actuator 122 and sprinklers 124. In some embodiments, environmental sensor 130 is associated with, but not physically conntected to, either actuator 122 or sprinkler 124. In other embodiments, environmental sensor 130 may be physically attached to actuator 122. In other embodiments, the environmental sensor 130 may be phyically connected to a sprinkler 124.

ISC 110 may include various input elements 112 accessible to a user via a chassis of ISC 110 or through a touch screen display. The input elements 112 may include real, virtual, or touch screen buttons, dial switches, slide selector switches, and other control elements. A user may employ control elements 112 to define a predetermined irrigation schedule. The predetermined irrigation schedule may represent the default irrigation schedule, i.e., the schdule that determines irrigation scheduling when no overiding condition is present.

When ISC 110 is executing the default schedule, ISC 110 selectively asserts the line out elements 140-1 through 140-n to control irrigation. In the embodiment depicted in FIG. 1, each line out 140 is connected, via a wired connection 142, to an actuator 122. An environmental sensor 130 is associated with each actuator 122. In other embodiments, an environmental sensor 130 may be associated with an individula sprinkler 124. In still other embodiment, two or more electronic sensors 130 may be associated with the same actuator 122. Assigning multiple sensors to a single actuator may facilitate a development or understanding of a profile of a studied characteristic.

In some embodiments, an environmental sensor 130 is physically distinct and detached from either sprinkler 124 or actuator 122. In these embodiments, an environmental sensor 130 is associated with an actuator 122 or a sprinkler 124 according to its position relative to the actuator 122 or sprinkler 124. In other embodiments, environmental sensor 130 may be physically connected to or integrated within either actuator 122 or sprinkler 124.

ISC 110 is operable to communicate with a source of network communication functionality enabling a user to communicate with networked elements. In the embodiment depicted in FIG. 1 for example, ISC 110 is operable to communicate with a source of weather forecast information identified herein as forecasting source 104.

ISC 110 as depicted in FIG. 1 may be operable to connect with one or more lawn care services 106. This embodiment might beneficially allow ISC 110 to communicate information received from or derived from an environmental sensor 130 to a lawn care service for purposes of requesting necessary services. If, for example, environmental data received via environmental sensor 130 indicates that the soil is nitrogen deficient, a service request might be issued to a lawn care service 106. The service request might include the information derived from the environmental sensor 130. The lawn care service 106 might respond with a recommendation to fertilize all or a portion of the area under consideration. In another embodiment, the environmental data received from environmental sensor 130 might be provided to a number of lawn care services 106 in the form of a request for bid. Lawn care service 106 might then respond to the request for bid by proposing a service and a cost associated with the cost. identifying and bidding on a service.

ISC 110 as depicted is further enabled to communicate with a networked source of weather forecast information identified as forecasting source 104. ISC 110 might be operable to retrieve forecasted weather information from forecasting source 104. ISC 110 might further be able to analyze the weather information and influence an irrigation system based on the information. If, as an example, information provided via forecasting source 104, indicated that the change of precipitation in a particular locality exceed 90%, ISC 110 might delay an irrigation scheduled for the following day.

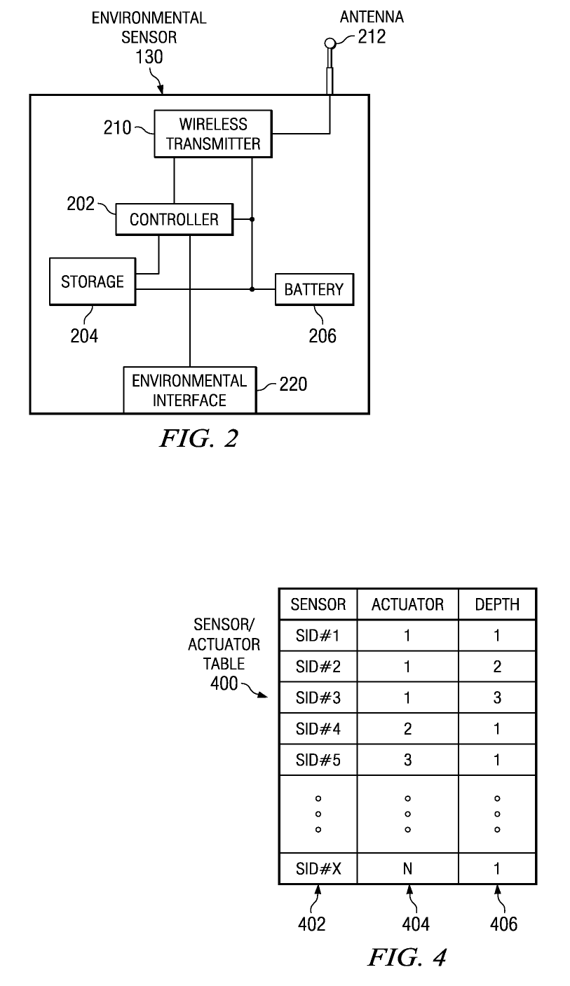

Turning now to FIG. 2, selected aspects of an embodiment of environmental sensor 130 are depicted. In the depicted embodiment, environmental sensor 130 includes a controller 202 and a storage medium 204 accessible to controller 202. A wireless transmitter 210 and an associated antenna 212 communicate with environmental interface 220. A battery 206 powers the components of environmental sensor 130.

Wireless transmitter 210 and antenna 212 may be operable to transmit wireless signals via any of a variety of wireless transmission protocols including, as examples, WiFi (802.11x protocols) or another suitable wireless transmission signals.

Environmental interface 220 may include elements suitable for being placed in contact with the soil and for extracting information about the composition and characteristics of the soil. An environmental sensor 130, for example, may be positioned in close proximity to an actuator 220 for determining the soil composition and/or moisture content in proximity to the environmental sensor 130. The environmental interface 220 may be suitable for obtaining a variety of types of information. For example, environmental sensor 130 may be capable of determining the moisture content of soil in proximity to environmental interface 220. As another example, environmental sensor 130 and environmental interface 220 may be operable to extract chemical composition information from the soil and transmit that information via transmitter 210 and antenna 212 to ISC 110. Environmental interface 220 may also be operable to determine current weather conditions including current precipitation conditions, an amount of water dispensed, a condition of a battery that may power environmental sensor 130, and other parameters of interest to one skilled in lawn maintenance and/or lawn care science.

Controller 202, in conjunction with software and/or firmware instructions stored in storage 204, may receive soil condition information from environmental interface 220 when environmental sensor 130 is inserted in the soil. Controller 202 may be operable to invoke wireless transmitter 210 to transmit environmental information wirelessly to a centralized controller such as ISC 110.

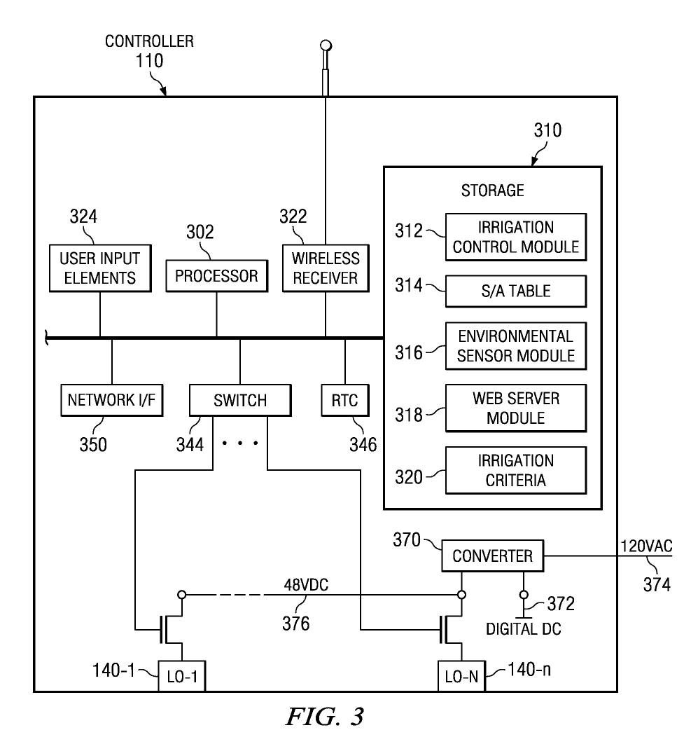

Turning now to FIG. 3, selected aspects of an exemplary embodiment of an ISC 110 are depicted. ISC 110 as depicted is configured to enable a user to define a default irrigation schedule or otherwise control the behavior of the TKP 110. The default schedule may operate until interrupted or otherwise overridden by irrigation criteria. The irrigation criteria might include criteria based on environmental information obtained from an environmental sensor 130, weather forecast information received from forecasting source 104, or another source.

As depicted in FIG. 3, ISC 110 includes a processor 302, computer readable storage 310 including processor executable instructions for an irrigation control module (ICM) 312. ISC 110 as shown further includes user input elements 324 suitable for receiving input signals from input elements 112 depicted in FIG. 1.

ISC 110 as depicted in FIG. 3 further includes a wireless receiver 320. Wireless receiver 320 is suitable for receiving information from environmental sensors 130 for altering 316 or to interpret envelope information 350 to receive weather and talk to lawn cares. IRC 312 may be guided or influenced by any or all of: user input elements 324, a defined schedule, environmental information, environmental sensor 130, weather information from weather explicitly 350, according to irrigation criteria. ISC 110 as depicted may further include a real time clock/global positioning (RTC/GPS) module 346 that may provide additional criteria parameters. ISC 110 receives 120 volt AC signal 374, as depicted in FIG. 3, which connects to a power converter 370. Power converter 370 may include AC to AC conversion as well as AC to AC capability. In the embodiment depicted in FIG. 3, converter 370 generates a DC logic signal 372 and a low voltage AC signal 376 that is used to drive the line out signals 140-1 through 140-n. In some embodiments, the low voltage AC signal 376 is a 24 V AC signal.

In some embodiments, ICM 312 is configured for selectively asserting one of the line out signals 140. A switch 344 operates in conjunction with ICM 312 to identify a particular line output 140. Assertion of a line out signal activates the actuator 122, which opens the valve and permits water to flow through the valve to the sprinkler or sprinklers 124.

Storage element 310 as depicted includes a web server module 318 and an environmental sensor module 316. In addition, storage 310 as shown may further include data structures including irrigation criteria 320 and a sensor/actuator table 314. Irrigation criteria 320 may encompass a set of rules and/or values operable to define one or more sets of conditions that would necessitate irrigation. Sensor actuator table 314 may be implemented as a lookup table enabling ISC 110 to maintain information pertaining to the relationship between a particular sensor and a particular actuator valve zone or sprinkler and a particular actuator, valve, zone, or sprinkler.

Referring to FIG. 4, an exemplary sensor/actuator table 400 suitable for use as table 314 includes a set of entries (rows) and a set of values associated with each row. The columns depicted in FIG. 4 include a sensor identifier column 402, and actuator identifier column 404, and a depth indicator column 406. The sensor identifier column 402 indicates a unique environmental sensor 130 of the system. The actuator identifier column 404 indicates actuator 122 that the corresponding environmental sensor 130 is associated with. In some embodiments, an actuator 122 is associated with the environmental sensor 130 that is located in closest proximity to the actuator.

In the depicted implementation of sensor/actuator table 400, multiple sensors can be associated with a single actuator. In FIG. 4, for example, sensor identifier column 404 indicates three entries associated with actuator “1”. Multiple sensors may be associated with a single actuator to develop a profile of the soil by locating each sensor at a different depth. Using sensors at different depths may facilitate the development of a depth profile for soil composition and/or moisture.

Returning back to FIG. 3, ISC 110 employs wireless receive 320 to receive wireless signals including wireless signals transmitted by environmental sensor 130. ISC 110 and ICM 312 are operable to analyze environmental information contained in the wireless signal and evaluate the information determined therein against criteria. In some embodiments, the environmental data included in the wireless signals received by wireless receiver 320 is used to override a user defined irrigation schedule when one or more irrigation criteria are satisfied. For example, an irrigation criterion might indicate that irrigation or watering is required whenever the moisture content drops below a specified threshold. As another example, information from environmental sensor 130 might be used to stop a scheduled irrigation. If, for example, the default irrigation schedule includes irrigating every Thursday beginning at 5:00 A.M., environmental sensor 130 might override the scheduled irrigation anytime the sensor detects that it is raining at 5:00 A.M. on a Thursday. In this embodiment, ISC 110 might then suspend all monitoring of environmental data for a period of time, e.g., 10 minutes to prevent an excessive number of system state transitions during intermittent rain showers. If, however, environmental sensor 130 detects no rain for a period that exceeds the defined period, ISC 110 may transition to a state in which no additional irrigation activity occurs until an environmental sensor 130 transmits a low moisture content signal. At that point, the system might return to its default scheduled program, begin to irrigate immediately, or take some other course of action.

In embodiments that include a network interface 350 enabling ISC 110 to communicate with an IP network, ISC 110 may include a web server module 318 that provides network visibility to ISC 110. In these embodiments, web server module 318 may support remote management of ISC 110 by permitting users to access and modify settings of ISC 110. The modified settings may include any settings accessible via use control elements 112.

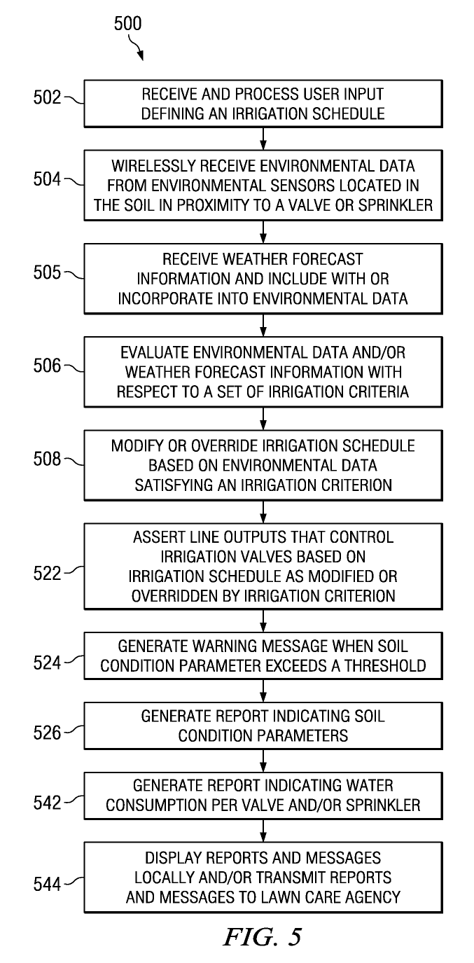

Some embodiments are implemented as software instructions stored on a computer readable medium such as the computer readable storage 310 in FIG. 3. Turning now to FIG. 5, selected elements of an embodiment of a method 500 for automating an irrigation system include receiving (block 502) and processing user input that defines an irrigation schedule. Environmental data is then wirelessly received (block 504) from an environmental sensor. The environmental sensor may be located within the soil in proximity to a valve or sprinkler.

Weather forecast information may also be received (block 505) from an external or remote source. The weather forecast information may be included with the environmental data. The environmental data and weather forecast information are then evaluated (block 506) with respect to irrigation criteria. The irrigation schedule may by modified or overridden (block 508) based on environmental data and/or weather forecasting information satisfying an irrigation criteria.

Based on environmental data and the weather forecast information, the irrigation schedule may be modified or overridden by irrigation and line outputs that control irrigation valves are then selectively asserted (block 522). A warning message may be generated (block 524) when soil conditions does not exceeds a threshold value. A report indicating soil condition parameters is then generated (block 526) and a report indicating water consumption per valve and/or sprinkler (block 524). Reports and messages are then displayed locally and/or transmitted and to a law care agency (block 544).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. An irrigation system controller, comprising:
a processor;
a computer readable storage medium accessible to the processor;
a wireless receiver operable for receiving a wireless signal from an environmental sensor;
a set of line outputs suitable for providing operational power to respective valve actuators; and
processor executable instructions in the storage medium, including:
an irrigation control module including instructions for:
interpreting user inputs to define an irrigation schedule; and
selectively asserting the set of line outputs based on the irrigation schedule; and
an environmental module including instructions for:
analyzing environmental data encoded in the wireless signal to determine whether irrigation criteria are satisfied; and
selectively asserting the set of line outputs based on results of said analyzing.

2. The controller of claim 1, wherein the environmental data is indicative of environmental conditions of soil in proximity to the environmental sensor.

3. The controller of claim 2, wherein the environmental data is indicative of a moisture content of the soil.

4. The controller of claim 1, further comprising a network interface configured to connect the controller to an Internet protocol network.

5. The controller of claim 4, wherein the wireless receiver is operable as the network interface.

6. The controller of claim 4, wherein the environmental module instructions further include instructions for:
receiving weather forecast information from a forecasting source via the network interface; and
including the weather forecast information with the environmental data during said analyzing wherein the weather forecast information influences whether the irrigation criteria is satisfied.

7. The controller of claim 4, wherein the processor executable instructions further include a web server module enabling the controller to receive the user inputs from a web browser.

8. The controller of claim 1, wherein the environmental data is indicative of a chemical composition of soil in proximity to the environmental sensor.

9. An irrigation control process, comprising:
extracting environmental information from a wireless signal responsive to receiving the wireless signal from an environmental sensor, wherein the environmental information is indicative of a condition of soil in proximity to the environmental sensor;
evaluating the environmental information with respect to irrigation criteria; and
selectively asserting a set of line outputs based on the evaluating when any of the irrigation criteria is satisfied.

10. The process of claim 9, further comprising:
determining an irrigation schedule based on user input; and
selectively asserting the set of line outputs based also on the irrigation schedule.

11. The process of claim 10, further comprising inhibiting said selectively asserting based on governmental irrigation restrictions.

12. The process of claim 9, wherein the environmental information is indicative of a chemical composition of the soil.

13. The process of claim 9, wherein the environmental information is indicative of moisture content of the soil.

14. The process of claim 9, further comprising:
responsive to receiving weather forecast information from a forecasting source, considering the weather forecast information when evaluating the environmental information with respect to the irrigation criteria.

15. A processor readable storage medium including processor executable instructions for controlling an irrigation system, the instructions comprising instructions to:
interpret environmental information extracted from a wireless environmental sensor signal wherein the environmental information is indicative of environmental conditions in proximity to an environmental sensor;
interpret weather forecast information received from a weather forecasting source;
evaluate the environmental information and the weather forecast information to determine whether any of a set of irrigation criteria is satisfied; and
assert a line output associated with the environmental sensor when an irrigation criterion is satisfied.

16. The storage medium of claim 15, wherein the environmental information is indicative of a chemical composition of soil in proximity to the environmental sensor.

17. The storage medium of claim 15, wherein the environmental information is indicative of a moisture content of soil in proximity to the environmental sensor.

18. The storage medium of claim 15, modifying the irrigation criteria based on at least one of a time of day, a season, and a geographical location.

19. The storage medium of claim 15, wherein the instructions further comprise instructions to:
respond to user input by defining an irrigation schedule; and
asserting the line output based on the irrigation schedule.

20. The storage medium of claim 19, wherein the instructions further comprise instructions to: enable a user to provide the user input via a web browser.

21. A method of automating an irrigation system, comprising enabling an irrigation system controller operating on a user defined schedule to:
wirelessly receive soil condition information from an environmental sensor;
evaluate the soil condition information for satisfaction of an irrigation criterion; and
activate an irrigation valve associated with the environmental sensor when the irrigation criterion is satisfied.

22. The method of claim 21, wherein the soil condition information is indicative of a chemical composition of the soil.

23. The method of claim 21, wherein the irrigation system controller is further enabled to generate a warning message based on the soil condition.

24. The method of claim 23, wherein the irrigation system controller is further enabled to send the warning message to a lawn care service.

25. The method of claim 21, wherein the irrigation system controller is further enabled to generate a report of the soil condition.

26. The method of claim 21, wherein the irrigation system controller is further enabled to generate a report indicative of water consumption per irrigation valve.

27. A sprinkler for use in an irrigation system, comprising:
a sprinkler head in communication with a fluid conduit; and
an environmental sensor positioned wherein the environmental sensor is embedded in soil when the sprinkler is installed and wherein the environmental sensor is operable to:
monitor parameters selected from the group consisting of:
a chemical composition of the soil;
a moisture content of the soil;
a precipitation status;
a volume of water dispensed by the sprinkler; and
a low battery condition of the environmental sensor; and
wirelessly transmit a signal indicative of at least some of the monitored parameters.
